(19) United States
(12) Patent Application Publication
(10) Pub. No.: US 2026/0365091 A1
(43) Pub. Date: Nov. 19, 2026

(54) CAR SEAT LATCH SYSTEM WITH FORCE ATTENUATION CAPABILITIES

(71) Applicant: Transtek Industries Inc., Dover, DE (US)

(72) Inventors: Daniele Inkenbrandt, Carson, VA (US); Michael H. Gillett, Silver Creek, WA (US)

(21) Appl. No.: 19/206,758

(22) Filed: May 13, 2025

(51) Int. Cl. B60N 2/28

(52) U.S. Cl. CPC B60N 2/2884; B60N 2/2893

(57) ABSTRACT

A child car seat configured to attenuate sudden forces, the car seat comprising a base configured to support a child seated thereon. A belt is connected to the base and includes a proximal end portion connected to the base, a distal end portion, and a force attenuating portion between the proximal end portion and the distal end portion. The force attenuating portion is configured to increase in length in response to a tensile force of a prescribed magnitude being applied to the belt which urges the distal end portion away from the proximal end portion. A LATCH connector is coupled to the distal end portion of the belt and is configured to be selectively attachable to a LATCH anchor on a vehicle.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### Technical Field

The present disclosure relates generally to child car seats and more specifically to a LATCH connector belt for use on a car seat and adapted to attenuate sudden forces applied to the car seat.

### 2. Description of the Related Art

According to the National Highway Traffic Safety Administration (NHTSA), car crashes are a leading cause of death for children in the United States. Child car seats play a central role in enhancing the safety of a child seated within a vehicle by preventing injuries and fatalities in the event of a crash. Studies have shown that proper use of car seats may reduce the risk of fatal injury by 71% for infants and by 54% for toddlers in passenger vehicles. These statistics underscore not only the life-saving potential of child restraint systems but also the importance of correct usage and installation.

Child car seats are designed to provide age-appropriate restraint and protection for children whose smaller frames and developing bodies are especially vulnerable during collisions. It is common for infants and toddlers to be seated in rear-facing seats as long as possible, typically until at least age two or until they reach the height or weight limit of the seat. Forward-facing seats with a five-point harness offer protection for older toddlers and preschoolers, followed by booster seats for school-aged children until adult seat belts fit properly.

One of the more important innovations in improving the usability and safety of car seats has been the LATCH system—Lower Anchors and Tethers for CHildren. This system was federally mandated in the United States in 2002 to simplify the installation of car seats and reduce the misuse associated with seat belt installation. The LATCH system includes built-in anchors in the vehicle and corresponding connectors on the car seat. The lower anchors are located in the crease between the vehicle seat back and cushion, while the tether anchor is typically located behind the seat, such as on the rear shelf, seatback, or floor.

The LATCH system is especially useful for caregivers who may struggle with correctly routing and tightening seat belts during installation. By providing dedicated anchor points, LATCH can increase the likelihood of a secure fit, reducing the chances of excessive movement or incorrect angle.

Although conventional car seats provide enhanced safety to a child while seated in a vehicle, conventional car seats do not provide complete protection during all driving events. For instance, sudden braking can pose a serious danger to a child, even when they are properly secured in a car seat. In a rapid deceleration event, the child’s body experiences significant forward momentum. While a well-installed car seat with a snug harness is designed to absorb and distribute crash forces across the strongest parts of the child’s body, the abrupt stop can still result in strain to the neck, spine, or internal organs due to their relatively delicate and developing anatomy.

Accordingly, there is a need in the art for an improved child seat that is configured to dampen or attenuate forces to enhance the overall safety for the child seated therein. Various aspects of the present disclosure address this particular need, as will be discussed in more detail below.

### BRIEF SUMMARY

In accordance with one embodiment of the present disclosure, there is provided a child car seat configured to attenuate sudden forces. The child car seat comprises a base configured to support a child seated thereon. A belt is connected to the base and includes a proximal end portion connected to the base, a distal end portion, and a force attenuating portion between the proximal end portion and the distal end portion. The force attenuating portion is configured to increase in length in response to a tensile force of a prescribed magnitude being applied to the belt which urges the distal end portion away from the proximal end portion. A LATCH connector is coupled to the distal end portion of the belt and is configured to be selectively attachable to a LATCH anchor on a vehicle.

The belt may be folded over itself at the force attenuating portion. The child car seat may additionally include a sacrificial stitch configured to hold portion of the belt folded over itself when the tensile force is below the prescribed magnitude. The sacrificial stitch may be configured to rupture when the tensile force is above the prescribed magnitude.

The belt may include a loop at the force attenuating portion.

According to another embodiment, there is provided an attachment belt assembly for connecting a child safety seat having a base to a LATCH anchor on a vehicle. The attachment belt assembly includes a belt connected to the base and having a proximal end portion connectable to the base, a distal end portion, and a force attenuating portion between the proximal end portion and the distal end portion. The force attenuating portion is configured to increase in length in response to a tensile force of a prescribed magnitude being applied to the belt which urges the distal end portion away from the proximal end portion. A LATCH connector is coupled to the distal end portion of the belt and is configured to be selectively attachable to a LATCH anchor on a vehicle.

According to a further embodiment, there is provided a method of dissipating forces in a child car seat. The method includes receiving a tensile force on a belt connected to a base configured to support a child seated thereon. The belt includes a proximal end portion connected to the base, a distal end portion, and a force attenuating portion between the proximal end portion and the distal end portion. The tensile force is applied to the belt to urge the distal end portion away from the proximal end portion. The method further includes elongating the force attenuating portion when the received tensile force is above a prescribed magnitude.

The elongating step may include rupturing a stitch holding a bunched segment of the force attenuating portion to enable straightening of the bunched segment. The bunched segment may include a folded portion of the belt. The bunched segment may include a looped portion of the belt.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper side perspective view of a car seat having a LATCH mounting system;

FIG. 2A is a top view of one embodiment of a LATCH connector belt used in the car seat and having force attenuating capabilities, the belt being depicted in a stitched configuration;

FIG. 2B is a top view of the LATCH connector belt in an expanded configuration;

FIG. 3 is a side, partial cross sectional view depicting the LATCH connector belt in the stitched/looped configuration and attached to a base of the car seat;

FIG. 4 is a side, partial cross sectional view depicting the LATCH connector belt in the stitched/folded configuration and attached to the base of the car seat;

FIG. 5 is a top view of the connector belt; and

FIG. 6 is a side view of the connector belt of FIG. 5.

Common reference numerals are used throughout the drawings and the detailed description to indicate the same elements.

### DETAILED DESCRIPTION

The detailed description set forth below in connection with the appended drawings is intended as a description of certain embodiments of a LATCH connector belt and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating a preferred embodiment of the present disclosure, and are not for purposes of limiting the same, there is depicted a car seat 10 having a connector belt 12 adapted to facilitate attachment of the car seat 10 to an anchor or mount 14 on the vehicle. The connector belt 12 may be specifically configured and adapted to attenuate or dampen forces caused by sudden movement of the vehicle to which the car seat 10 is connected. For instance, when the vehicle experiences a sudden deceleration that results in a force being applied to the car seat 10 above a prescribed magnitude, the connector belt may be configured to absorb the forces to allow the car seat 10 to undergo a more gradual deceleration, thereby reducing the forces experienced by the child seated in the car seat. As such, the car seat 10 may be capable of reducing injury to the child, and may be a safer alternative to conventional car seats.

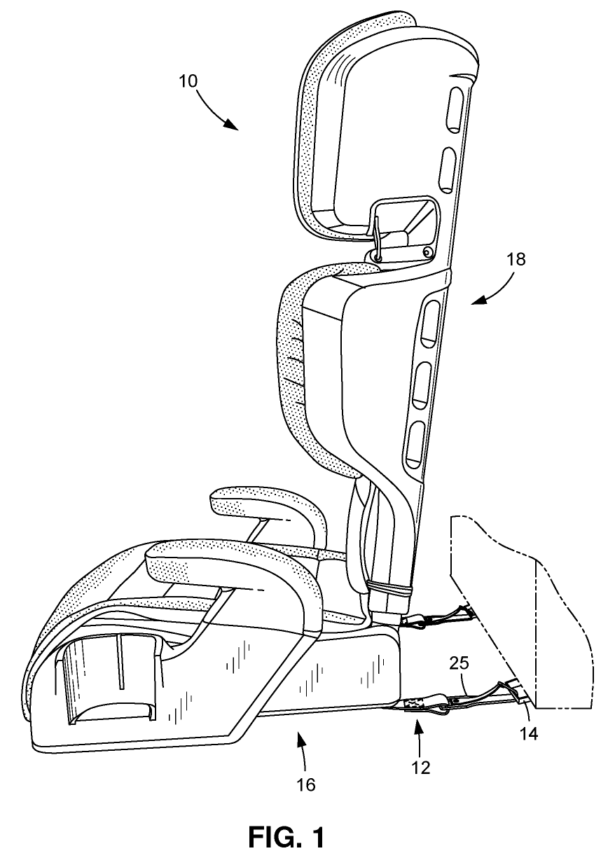

Referring now specifically to FIG. 1, a car seat 10 is shown having a base 16 and a seat back 18 connected to the base 16. The base 16 may include a seating surface on which a child may be seated or supported, and the seat back 18 may extend upward from the base 16 to support the back of the child seated in the seat 10. The seat back 18 may be detachable from the base 16 to allow the base 16 to be used with or without the seat back 18. Both the base 16 and the seat back 18 may include padding to enhance the comfort to the child seated on the car seat 10. An exemplary car seat 10 includes the DIONO CONNECT3 RXT 2-in-1 HIGH BACK BOOSTER, as well as that which is disclosed in U.S. Patent Application Publication No. 2024/0123877, entitled BOOSTER SEAT CONFIGURED FOR COMPACT SIDE-BY-SIDE POSITIONING, owned by DIONO, LLC, the contents of which are expressly incorporated herein by reference. Although the exemplary car seat 10 depicted in FIG. 1 is adapted for use by older children, it is also understood that the force attenuation modalities described herein may also be used on infant car seats, having a base adapted to connect with an infant carrier. In this regard, it is contemplated that the force attenuating modalities may be integrated into any connector belt 12 intended to be connected to a LATCH anchor, or similar mounting structure, on a vehicle.

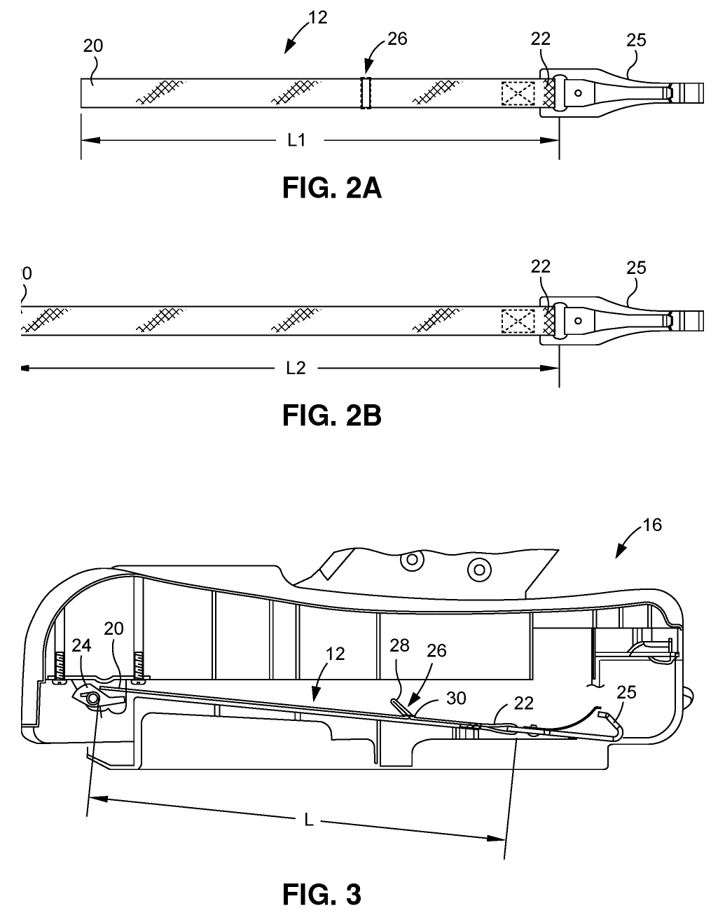

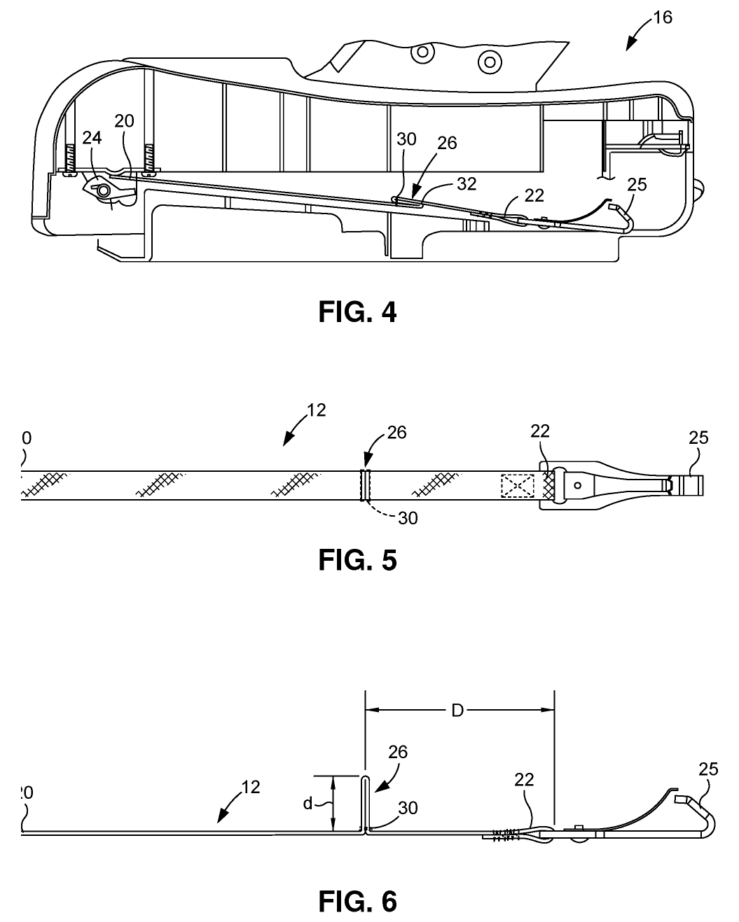

Referring now to FIGS. 2A, 2B and 3, the connector belt 12 is an elongate structure (e.g., having a length greater than a width) that includes a proximal end portion 20 and a distal end portion opposite 22 the proximal end portion 20. The proximal end portion 20 is configured to be engageable to the base 16. In one embodiment, the base 16 may include a clamp 24, spool, or other structure to which the proximal end portion 20 may be secured. The clamp (or other structure) 24 may allow for selective adjustment of the connector belt 12 to increase an effective length L of the belt 12. As used herein, the effective length L (see FIG. 3) of the belt 12 may refer to the distance between the clamp 24 and a distal most portion of the distal end portion 22, or the portion of the belt 12 that is exposed outside of the base 16, or the distance between the clamp 24 and a LATCH connector 25 coupled to the distal end portion 22 of the belt 12. As will be explained in more detail below, the effective length of the belt 12 may transition from a shortened effective length L1 (see FIG. 2A) during normal driving events, and a lengthened effective length L2 (see FIG. 2B) in response to a significant vehicle deceleration, wherein the transition from the shortened effective length L1 to the lengthened effective length L2 dampens forces experienced by the child seated in the car seat 10.

In more detail, the connector belt 12 includes force attenuating segment 26 between the proximal end portion 20 and the distal end portion 22. The force attenuating segment 26 is configured to absorb a force and elongate in response to a sudden breaking force experienced by the vehicle and applied to the car seat 10. In this regard, the force attenuating segment 26 includes a portion that is inactive during normal operation, and thus, does not experience tensile forces within the connector belt 12. Thus, as the LATCH connector 25 is pulled away from the clamp 24, the inactive segment of material may not experience increased tensile forces that the other portions of the belt 12 may experience. Furthermore, given that the inactive segment is bunched up, the force attenuating segment 26 may have the shortened effective length L1 during normal operation of the connector belt 12. However, when the tensile forces rise above a prescribed threshold, such as during a sudden deceleration, part of the force attenuating segment 26 may rupture, tear or otherwise break, resulting in the previously inactive segment becoming activated by experiencing the tension in the connector belt 12. In addition, the now-activated segment of the connector belt 12 results in an increased effective length L2. In this regard, the force attenuating segment 26 may transition from the shortened-inactive length and the activated-lengthened length when the prescribed tensile force is above the prescribed magnitude.

In one embodiment, the force attenuating segment 26 includes a loop 28 that remains in its looped configuration during normal operation, but which becomes undone and extended in response to the prescribed breaking force. In this regard, when in the looped configuration, the force attenuating segment 26 is inactive, and when transitioned out of the looped configuration, the force attenuating segment 26 becomes active. The loop 28 may be held together or in place by one or more stitches (e.g., rip stitches) 30 that holds the loop 28 together during normal operation. The stitch(es) 30 can rupture or become undone in response to tension in the belt 12 being above the prescribed magnitude. When the stitch 30 becomes undone, the loop 28 transitions from the inactive/looped configuration to an active/straight configuration, which effectively lengthens the connector belt 12, and in the process dampens the forces applied to the base. The force dampening may be attributable to the force absorption associated with ripping the stitch(es) 30.

The loop may have a maximum dimension d that may be equal to 30-80 mm, and more specifically, approximately 52.5 mm. Furthermore, the loop may be spaced from the distal-most portion of the connector belt 12 by a distance D between 10-30 cm, and more specifically, approximately 19 cm.

In another embodiment, the force attenuating segment 26 includes a folded section 32 that is held together by one or more rip stitches 30. During normal operation, the folded section remains in an inactive/folded configuration. However, when tension in the belt 12 is above the prescribed magnitude, the rip stitch(es) 30 comes undone to allow the folded section to transition from its folded configuration toward a straight configuration, thereby elongating the belt 12 in the process and dampening the forces applied to the base.

In both embodiments, the force attenuating segment 26 includes a belt overlap during normal operation of the belt 12. In the looped embodiment, the overlap is created by the loop, while in the folded embodiment, the overlap is created by the folds. When the tension causes the stitch to become undone, the degree of overlap is reduced or eliminated to allow the belt 12 to lengthen.

It is contemplated that the force attenuating segment 26 may be integral with, and be a continuation of, the proximal end portion 20 and distal end portion 22. In this regard, the force attenuating segment 26 may be formed from the same material as the proximal and distal end portions 20, 22, such as woven nylon. As such, when activated, the force attenuation segment may have the same response characteristics (elasticity, etc.) as the proximal and distal end portions 20, 22. However, in an alternative embodiment, the force attenuation segment 26 may be formed of a different material than that of the proximal and distal end portions 20, 22. For instance, the proximal and distal end portions 20, 22 may be formed of woven nylon, while the force attenuation segment 26 may be formed of a material that is more elastic than the proximal and distal end portions 20, 22. The different material may enhance the ability of the force attenuation segment 26 to absorb the deceleration forces.

Furthermore, while the exemplary embodiment shows the force attenuating segment 26 as including either a loop 28 or a folded section 32, it is contemplated that other embodiments of the force attenuating segment 26 may adopt other force attenuating modalities to dampen the force. For instance, the force attenuating segment 26 may include a folded segment that is held together by hook and loop fasteners that are resistant to becoming disconnected when tension in the belt 12 is below a prescribed magnitude, but will become disconnected when the tension is above a prescribed magnitude. The process of the hook and loop fasteners becoming disconnected may dissipate the force to provide a dampening effect on the movement of the car seat 10.

The connector belts 12 may be assembled into the car seat 10 during the original assembly of the car seat 10, while other implementations of the connector belt 12 may be configured to be retrofitted onto the car seat 10. Thus, the ability to retrofit the connector belt 12 may allow the connector belt 12 to be installed on car seats that may not have force attenuating capabilities. In this regard, the connector belts 12 may be sold as a standalone product for installation on existing car seats. Furthermore, the ability to retrofit the connector belt 12 onto the car seat 10 may be a desirable feature given that certain embodiments of the connector belt 12 may be sacrificial as the rip stitch 30 comes undone. In this regard, once the rip stitch 30 comes undone, it may be undesirable to use that connector belt 12 as the ability to attenuate forces may be compromised. Thus, being able to remove the used connector belt 12 and replace it with a new connector belt 12 may allow the car seat 10 to be used for the remainder of its useful life.

While certain embodiments of the connector belt 12 are sacrificial and intended for one-time transition from the inactive state toward the active state, other embodiments, such as the hook and loop embodiment described above, may not be reusable, thus, allowing the connector belt 12 to be reset after deployment and reused with the car seat.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A child car seat configured to attenuate sudden forces, the child car seat comprising:
a base configured to support a child seated thereon;
a belt connected to the base and having a proximal end portion connected to the base, a distal end portion, and a force attenuating portion between the proximal end portion and the distal end portion, the force attenuating portion being configured to increase in length in response to a tensile force of a prescribed magnitude being applied to the belt which urges the distal end portion away from the proximal end portion; and
a LATCH connector coupled to the distal end portion of the belt and configured to be selectively attachable to a LATCH anchor on a vehicle.

2. The child car seat recited in claim 1, wherein the belt is folded over itself at the force attenuating portion.

3. The child car seat recited in claim 2, further comprising a sacrificial stitch configured to hold portion of the belt folded over itself when the tensile force is below the prescribed magnitude.

4. The child car seat recited in claim 3, wherein the sacrificial stitch is configured to rupture when the tensile force is above the prescribed magnitude.

5. The child car seat recited in claim 1, wherein the belt includes a loop at the force attenuating portion.

6. The child car seat recited in claim 5, wherein the belt include a sacrificial stitch configured to hold the loop in place when the tensile force is below the prescribed magnitude.

7. The child car seat recited in claim 6, wherein the sacrificial stitch is configured to rupture when the tensile force is above the prescribed magnitude.

8. The child car seat recited in claim 1, wherein the belt is formed of woven nylon.

9. An attachment belt assembly for connecting a child safety seat having a base to a LATCH anchor on a vehicle, the attachment belt assembly comprising:
a belt connected to the base and having a proximal end portion connectable to the base, a distal end portion, and a force attenuating portion between the proximal end portion and the distal end portion, the force attenuating portion being configured to increase in length in response to a tensile force of a prescribed magnitude being applied to the belt which urges the distal end portion away from the proximal end portion; and
a LATCH connector coupled to the distal end portion of the belt and configured to be selectively attachable to a LATCH anchor on a vehicle.

10. The child car seat recited in claim 9, wherein the belt is folded over itself at the force attenuating portion.

11. The child car seat recited in claim 10, further comprising a sacrificial stitch configured to hold portion of the belt folded over itself when the tensile force is below the prescribed magnitude.

12. The child car seat recited in claim 11, wherein the sacrificial stitch is configured to rupture when the tensile force is above the prescribed magnitude.

13. The child car seat recited in claim 9, wherein the belt includes a loop at the force attenuating portion.

14. The child car seat recited in claim 13, wherein the belt include a sacrificial stitch configured to hold the loop in place when the tensile force is below the prescribed magnitude.

15. The child car seat recited in claim 14, wherein the sacrificial stitch is configured to rupture when the tensile force is above the prescribed magnitude.

16. The child car seat recited in claim 9, wherein the belt is formed from woven nylon.

17. A method of dissipating forces in a child car seat, the method comprising the steps of:
receiving a tensile force on a belt connected to a base configured to support a child seated thereon, the belt having a proximal end portion connected to the base, a distal end portion, and a force attenuating portion between the proximal end portion and the distal end portion, the tensile force being applied to the belt to urge the distal end portion away from the proximal end portion; and
elongating the force attenuating portion when the received tensile force is above a prescribed magnitude.

18. The method as recited in claim 17, wherein the elongating step includes rupturing a stitch holding a bunched segment of the force attenuating portion to enable straightening of the bunched segment.

19. The method as recited in claim 18, wherein the bunched segment includes a folded portion of the belt.

20. The method as recited in claim 18, wherein the bunched segment includes a looped portion of the belt.
